(19) United States
(12) Patent Application Publication
(10) Pub. No.: US 2005/0052419 A1
(43) Pub. Date: Mar. 10, 2005

(54) Hand-held electronic device with improved keyboard

(75) Inventor: Brandon Stuart Burroughs, San Diego, CA (US)

Correspondence Address: PROCOPIO, CORY, HARGREAVES & SAVITCH LLP, 530 B STREET, SUITE 2100, SAN DIEGO, CA, 92101, US

(73) Assignee: Kyocera Wireless Corp.

(21) Appl. No.: 10/646,430

(22) Filed: Aug. 22, 2003

(51) Int. Cl. G09G 5/00

(52) U.S. Cl. 345/168

(57) ABSTRACT

A method of using a keyboard for a handheld electronic device includes providing a thumb keyboard for a handheld electronic device having a left set of one or more rows of input keys and a right set of one or more rows of input keys separated by a centerline, the left set of one or more rows are opposite the right set of one or more rows, and lines drawn through the left-most input key and the right most input key of opposite rows intersect the centerline to form a generally upwards v shape; using only the left thumb to input information into the handheld electronic device using the left set of one or more rows of input keys; and using only the right thumb to input information into the handheld electronic device using the right set of one or more rows of input keys.

### FIELD OF THE INVENTION

The present invention is, in general, in the field of keyboards for hand-held electronic devices, and, in particular, in the field of QWERTY thumb keyboards for hand-held electronic devices.

### BACKGROUND OF THE INVENTION

Numerous hand-held electronic devices have been developed with QWERTY keyboards. A QWERTY keyboard is the standard typewriter and computer keyboard in countries that use a Latin-based alphabet, and QWERTY refers to the first six letters on the upper row of the keyboard. For example, U.S. Pat. No. 6,396,482 describes a hand-held electronic device with a keyboard designed for thumb-based data entry. Because it is becoming more common to integrate standard PDA or PIM features (e.g., address book, electronic calendar, task list, and other text-based features) into hand-held electronic devices (e.g., mobile phones, two-way paging devices), QWERTY thumb keyboards are advantageous for the efficient entry of data into such devices. A problem with the thumb keyboard described in U.S. Pat. No. 6,396,482 and elsewhere in the prior art is that they are uncomfortable to use, especially when used frequently.

### SUMMARY OF THE INVENTION

The above drawback and others are addressed by the improved thumb-based QWERTY keyboard of the present invention. Unlike prior thumb-based QWERTY keyboards in the past, the thumb-based QWERTY keyboard of the present invention is thumbcentric. The keyboard is divided into one or more left keyboard sections optimized for use with the left thumb and one or more right keyboard sections optimized for use with the right thumb. This layout makes thumb data entry more ergonomic, comfortable, easy to use, and faster than in the past.

Further objects and advantages will be apparent to those skilled in the art after a review of the drawings and the detailed description of the preferred embodiments set forth below.

### BRIEF DESCRIPTION OF THE DRAWINGS

FIG. 1 is a front elevational view of a mobile phone including a thumbcentric keyboard constructed in accordance with an embodiment of the invention.

FIG. 2 is a front elevational view of a mobile phone including a thumbcentric keyboard constructed in accordance with another embodiment of the invention.

### DETAILED DESCRIPTION OF PREFERRED EMBODIMENTS

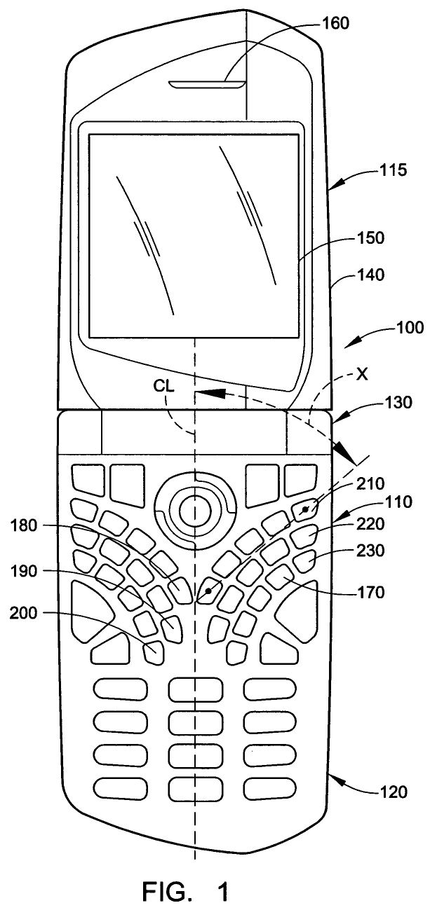

With reference to FIG. 1, an embodiment of a mobile phone 100 including a thumbcentric QWERTY keyboard 110 constructed in accordance with an embodiment of the invention will be now be described. Although the thumbcentric keyboard 110 will be shown and described as having a QWERTY keyboard layout, in alternative embodiments, the thumbcentric keyboard 110 may have a keyboard layout other than a QWERTY keyboard layout such as, but not limited to, a DVORAK keyboard layout. Further, although the thumbcentrc keyboard 110 will be shown and described in conjunction with a mobile phone 100, in alternative embodiments, the thumbcentric keyboard 110 may be used with or part of other hand-held electronic devices besides mobile phones such as, but not by way of limitation, PDAs, two-way paging devices.

Before describing the thumbcentric keyboard 110, the mobile phone 100 will be generally described. The mobile phone 100 includes a clam shell design with an upper mobile phone member 115 pivotally attached to a lower mobile phone member 120 through a pivoting mechanism 130. The upper mobile phone member 115 includes an upper member housing 140 that carries a display 150 and a speaker 160 located above the display 150. The lower mobile phone member 120 includes a lower member housing 165 with a plurality of input keys 170 for inputting information into the mobile phone 100 and carries a microphone (not shown). The upper mobile phone member 115 and/or the lower mobile phone member 120 carry suitable electronics and/or software for operation of the mobile phone 100 and to provide functionality to inputs received from the input keys 170.

In the embodiment shown, the thumbcentric QWERTY keyboard 110 includes those input keys 170 in upper left row 180, middle left row 190, lower left row 200, upper right row 210, middle right row 220, and lower right row 230. In the embodiment shown, the rows 180-230 are aligned along respective arcs. The left rows 180-200 include respective arc centers that lie to the left of centerline CL. The right rows 210-230 include respective arc centers that lie to the right of centerline CL. The centerline CL may be the centerline of symmetry for the mobile phone 100 and/or the keyboard 110. The centerline CL may divide the QWERTY keyboard 110 into symmetric or corresponding left rows 180-200 and right rows 210-230. The plane along the centerline CL that divides the QWERTY keyboard 110 into symmetric or corresponding left rows and right rows is a centerplane.

One or more of the respective arc centers of the left rows 180-200 may be located at the same point, may be collinear, may be collinear and lie in a plane coplanar with the centerline CL, may be collinear and lie in a plane perpendicular to the centerline CL, or may lie at non-collinear points. Similarly, one or more of the respective arc centers of the right rows 210-230 may be concentric, may be collinear, may be collinear and lie in a plane coplanar with the centerline CL, may be collinear and lie in a plane perpendicular to the centerline CL, or may lie at non-collinear points. In the shown embodiment, where rows 180-230 are aligned along respective arcs, arc may have respective radii of curvature between 10 mm and infiniti.

The upper right row 210 is oriented at an angle X with respect to the centerline CL. The angle X is defined as the angle formed by the intersection of the centerline CL with the line drawn through the center of the left-most key in the row 210 and the right-most key in the row 210, and may range between 0 and 90 degrees. Similarly, the other rows 180-200, 220-230 are oriented at respective angles with respect to the centerline CL. One or more of the angles that the rows 180-230 are oriented at with respect to the centerline CL may be the same or different. Preferably, the angle is the same for opposite rows (i.e., the angle for the upper left row 180 is the same for the upper right row 210, the angle for the middle left row 190 is the same for the middle right row 220, the angle for the lower left row 200 is the same for the lower right row 230).

In an alternative embodiment, the input keys 170 in each row 180-230 may be oriented in a straight line oriented at an angle X with respect to the centerline CL ranging between 0 and 90 degrees. In this embodiment, the lines of opposite rows 180-230 form an upwards “V” shape with the vertex being along the centerline CL.

As used herein a “thumbcentric” keyboard is a thumb keyboard where opposite rows are either angled in an upwards “V” shape or if the opposite rows form arcs, the respective arc centers for the left rows are to the left of the centerline CL and the respective arc centers for the right rows are to the right of the centerline CL.

Although multiple left rows 180-200 and multiple right rows 210-230 are shown and described, in alternative embodiments, the mobile phone 100 may have a number of left rows and/or right rows other than 3 (e.g. 1, 2, 4, 5, etc.).

Further, although the mobile phone 100 is shown and described as having a clam-shell design, in alternative embodiments, the hand-held electronic device may have a configuration other than a clam-shell design and/or may be a hand-held electronic device other than a mobile phone.

In use, a user grabs the mobile phone 100 with one's hands at a more natural angle than with QWERTY thumb keyboards in the past. The user enters characters corresponding to input keys 170 in the left rows 180-200 by pressing on the input keys 170 in the left rows 180-200 with the left thumb and enters characters corresponding to input keys 170 in the right rows 210-230 by pressing on the input keys 170 in the right rows 210-230 with the right thumb. Compared to thumb QWERTY keyboards in the past, the thumbcentric QWERTY keyboard 110 with left rows 180-200 optimized for use with the left thumb and right rows 210-230 optimized for use with the right thumb makes thumb data entry more ergonomic, comfortable, easy to use, and faster than in the past.

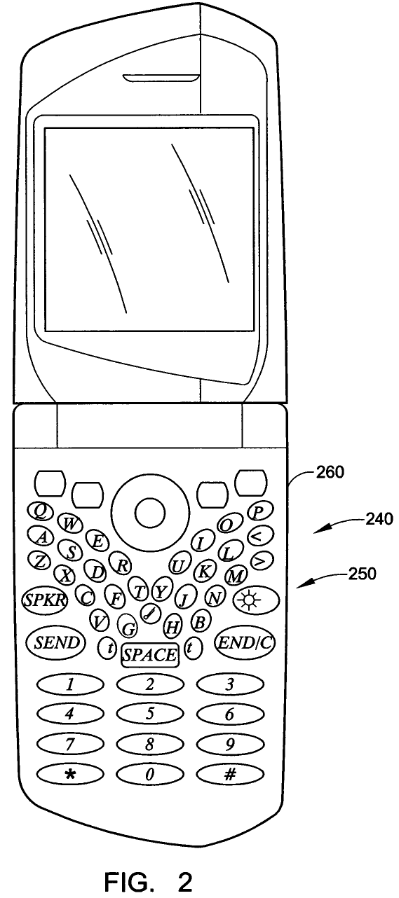

FIG. 2 is a front elevational view of a mobile phone 240 including a thumbcentric keyboard 250 constructed in accordance with another embodiment of the invention where most of the input keys 260 have an oval configuration and the input keys 260 of the thumbcentric keyboard 250 have a slightly different layout.

It will be readily apparent to those skilled in the art that still further changes and modifications in the actual concepts described herein can readily be made without departing from the spirit and scope of the invention as defined by the following claims.

1. A keyboard for a handheld electronic device, the keyboard configured for use with thumbs of a user and comprising: a left set of one or more rows of input keys and a right set of one or more rows of input keys separated by a centerline, the left set of one or more rows of input keys arranged in one or more respective arcs having one or more respective arc centers located to the left of the centerline, and the right set of one or more rows of input keys arranged in one or more respective arcs having one or more respective arc centers located to the right of the centerline.

2. The keyboard of claim 1, wherein the keyboard has a QWERTY keyboard layout.

3. The keyboard of claim 1, wherein the keyboard has a DVORAK keyboard layout.

4. The keyboard of claim 1, wherein the one or more respective arc centers of the left set of one or more rows of input keys are concentric and the one or more respective arc centers of the right set of one or more rows of input keys are concentric.

5. The keyboard of claim 1, wherein the one or more respective arc centers of the left set of one or more rows of input keys are collinear and the one or more respective arc centers of the right set of one or more rows of input keys are collinear.

6. The keyboard of claim 1, wherein the one or more respective arc centers of the left set of one or more rows of input keys are collinear and located in at least one of a vertical line and a horizontal line and the one or more respective arc centers of the right set of one or more rows of input keys are collinear and located in at least one of a vertical line and a horizontal line.

7. The keyboard of claim 1, wherein the respective arcs of the left set of one or more rows of input keys and the respective arcs of the right set of one or more rows of input keys include radii of curvature between 10 mm and infiniti.

8. The keyboard of claim 1, wherein the respective angles formed by respective arcs of the left set of one or more rows of input keys and the respective arcs of the right set of one or more rows of input keys are between 0 and 90 degrees with respect to the centerline.

9. The keyboard of claim 1, wherein each row of the one or more rows of each set include a left-most input key and a right-most input key, the left set of one or more rows are opposite the right set of one or more rows, and lines drawn through the left-most input key and the right most input key of opposite rows intersect the centerline to form a generally upwards V shape.

10. A keyboard for a handheld electronic device, the keyboard configured for use with thumbs of a user and comprising: a left set of one or more rows of input keys and a right set of one or more rows of input keys separated by a centerline, the left set of one or more rows are opposite the right set of one or more rows, and lines drawn through the left-most input key and the right most input key of opposite rows intersect the centerline to form a generally upwards V shape.

11. The keyboard of claim 10, wherein the keyboard has a QWERTY keyboard layout.

12. The keyboard of claim 10, wherein the keyboard has a DVORAK keyboard layout.

13. The keyboard of claim 10, wherein the lines drawn through the left-most input key and the right most input key of each row intersect at the centerline to form an angle with respect to the centerline that is between 0 degrees and 90 degrees.

14. The keyboard of claim 10, wherein the left set of one or more rows of input keys are arranged in one or more respective arcs having one or more respective arc centers located to the left of the centerline, and the right set of one or more rows of input keys are arranged in one or more respective arcs having one or more respective arc centers located to the right of the centerline.

15. The keyboard of claim 14, wherein the respective arcs of the left set of one or more rows of input keys and the respective arcs of the right set of one or more rows of input keys include radii of curvature between 10 mm and infiniti.

16. A method of using a keyboard for a handheld electronic device with left and right thumbs of a user, the method comprising:
providing a thumb keyboard for a handheld electronic device including a left set of one or more rows of input keys and a right set of one or more rows of input keys separated by a centerline, the left set of one or more rows are opposite the right set of one or more rows, and lines drawn through the left-most input key and the right most input key of opposite rows intersect the centerline to form a generally upwards V shape;
using only the left thumb to input information into the handheld electronic device using the left set of one or more rows of input keys;
using only the right thumb to input information into the handheld electronic device using the right set of one or more rows of input keys.

17. The method of claim 16, wherein the keyboard has at least one of a QWERTY keyboard layout and a DVORAK keyboard layout.

18. The method of claim 16, wherein the lines drawn through the left-most input key and the right most input key of each row intersect at the centerline to form an angle with respect to the centerline that is between 0 degrees and 90 degrees.

19. The method of claim 16, wherein the left set of one or more rows of input keys are arranged in one or more respective arcs having one or more respective arc centers located to the left of the centerline, and the right set of one or more rows of input keys are arranged in one or more respective arcs having one or more respective arc centers located to the right of the centerline.

20. The method of claim 19, wherein the respective arcs of the left set of one or more rows of input keys and the respective arcs of the right set of one or more rows of input keys include radii of curvature between 10 mm and infiniti.
